(19) United States
(12) Patent Application Publication
(10) Pub. No.: US 2015/0223076 A1
(43) Pub. Date: Aug. 6, 2015

(54) Software definable transceiver apparatus and method

(71) Applicant: John Santhoff, Escondido, CA (US)

(72) Inventor: John Santhoff, Escondido, CA (US)

(21) Appl. No.: 14/544,703

(22) Filed: Feb. 6, 2015

Related U.S. Application Data
(60) Provisional application No. 61/936,768, filed on Feb. 6, 2014.

(51) Int. Cl. H04W 16/14; H04L 29/14; H04L 12/24; H04L 25/02; H04L 25/08

(52) U.S. Cl. CPC H04W 16/14; H04L 25/0264; H04L 25/085; H04L 41/022; H04L 69/40

(57) ABSTRACT

A software definable transceiver is provided. The transceiver is structured to receive a plurality of dissimilar communication signals, with each signal containing data associated with a dissimilar physical layer. An antenna communicates with a plurality of radio frequency (RF) receiving elements, each RF element optimized for each dissimilar communications signal, with the plurality of RF elements structured to process each of the received dissimilar communications signals. An analog-to-digital converter (ADC) communicates with each of the RF receiving elements, with the ADC structured to convert an analog signal into a digital signal. A plurality of baseband processor engines (BPEs) communicate with the ADC, each BPE having a random-access-memory (RAM) buffer, with each RAM buffer including a dissimilar physical layer representation, so that the digital signal is processed and formatted in each RAM buffer so each BPE outputs recovered data unique to each dissimilar communications signal.

Priority is claimed to provisional application Ser. No. 61/936,768, filed Feb. 6, 2014, entitled: “Software Definable Transceiver With Arbitrary Waveform Generator Supporting Multiple Simultaneous Physical Layers and Basebands,” which is referred to and incorporated herein in its entirety by this reference.

### FIELD OF THE INVENTION

The present invention generally relates to communications. More particularly, the invention concerns a software-definable radio transceiver.

### BACKGROUND OF THE INVENTION

The Information Age is upon us. Access to vast quantities of information through a variety of different communication systems are changing the way people work, entertain themselves, and communicate with each other.

For example, because of the 1996 Telecommunications Reform Act, traditional cable television program providers have now evolved into full-service providers of advanced video, voice and data services for homes and businesses. A number of competing cable companies now offer cable systems that deliver all of the just-described services via a single broadband network.

These services have increased the need for bandwidth, which is the amount of data transmitted or received per unit time. More bandwidth has become increasingly important, as the size of data transmissions has continually grown. Applications such as in-home movies-on-demand and video teleconferencing require high data transmission rates. Another example is interactive video in homes and offices.

In addition, many different standards have emerged for both wired and wireless digital communication systems. In the consumer wireless networking space there is Cellular, Wi-Fi, Bluetooth and Zigbee to name but a few. Additionally, other serial digital communications systems that are not networked, but are typically baseband or digital communications systems are ATSC Digital Television and ITU-T J.83 (QAM CATV).

In the consumer networking wired space there is Multimedia-Over-Coax-Alliance (MoCA), Home Phone line Networking Alliance (HPNA) and a multitude of power line networking solutions such as HomePlug and HomeGrid. Additionally, other serial communications systems that are not networked, but are typically baseband or serial digital communications are Universal Serial Bus (USB and IEEE-1394 (Firewire) systems.

There are other wireless and wired standards for both commercial and military applications, as well. Networked devices are now part of our day-to-day existence with no end in sight to their growth. The value of networking devices is best understood by looking at “Metcalfe's Law” which states: “The value of a telecommunications network is proportional to the square of the number of connected users of the system.”

With the development of all these different communication technologies, and the continual deployment of new devices and technologies there a need exists for a more flexible and adaptable communication apparatus.

### BRIEF DESCRIPTION OF THE DRAWINGS

Various embodiments of the present invention taught herein are illustrated by way of example, and not by way of limitation, in the figures of the accompanying drawings, in which:

FIG. 1 is a block diagram of a software definable transmitter embodying the principals of the invention;

FIG. 2 is a block diagram of another embodiment of a software definable transmitter embodying the principals of the invention;

FIG. 3 is an illustration of different communication methods;

FIG. 4 is an illustration of two ultra-wideband pulses; and

FIG. 5 depicts the current United States regulatory mask for outdoor ultra-wideband communication devices.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following description, for the purposes of explanation, numerous specific details are set forth in order to provide a thorough understanding of the software definable transceiver (hereafter “SDT”) that embodies principals of the present invention. It will be apparent, however, to one skilled in the art that the SDT may be practiced without some of these specific details. Throughout this description, the embodiments and examples shown should be considered as exemplars, rather than as limitations on the SDT. That is, the following description provides examples, and the accompanying drawings show various examples for the purposes of illustration. However, these examples should not be construed in a limiting sense as they are merely intended to provide examples of the SDT rather than to provide an exhaustive list of all possible implementations of the SDT.

Specific embodiments of the invention will now be further described by the following, non-limiting examples which will serve to illustrate various features. The examples are intended merely to facilitate an understanding of ways in which the invention may be practiced and to further enable those of skill in the art to practice the invention. Accordingly, the examples should not be construed as limiting the scope of the invention. In addition, reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

Unless defined otherwise, all technical and scientific terms used herein have the same meaning as is commonly understood by one of skill in the art to which this invention belongs. In event a definition is not consistent with definitions elsewhere, the definitions set forth herein will control.

The present invention relates to digital data communication systems. More specifically, it relates to a system and architecture for communicating multiple dissimilar digital physical (PHY) layer data over wireless and or wired PHY layer transport medias. In one embodiment, PHY layers are generated using a high-speed multi-Gigabit Digital-to-Analog-Converter (DAC) for the transmitter with an associated digital baseband processor for each PHY layer to be supported. Similarly, the receiver side comprises an inverse architecture that employs a high-speed Analog-to-Digital-Converters (ADC) with an associated digital baseband processor. One embodiment uses the DAC and ADC to massively oversample at multi-Gigabit sampling rates, thereby enabling higher signal-to-noise-ratios (SNR) and the ability to generate and receive multiple dissimilar PHY layers for both wireless and/or wired communications separated in the frequency domain without the need for Radio Frequency (RF) up-or down-conversion.

The present invention provides a systems and apparatus for software controllable arbitrary waveform generator capable of generating multiple physical (PHY) layer transports simultaneously. Each individual PHY layer transport is capable of operating independently or synchronized using different radio frequency (RF) spectrum. Each PHY is capable of operating with its own unique modulation and digital baseband processor. Additionally each PHY layer can correspond to the standard for a specific wireless and or wired specification. Put differently, one unique feature of the invention is that the arbitrary waveforms generated are compatible with a number of communications standards for both wireless and wired communications. The DAC is capable of simultaneously outputting multiple RF streams corresponding to the multiplicity of different wired and wireless standards.

Modern semiconductor technology allows semiconductor electronic circuits to operate at tens of Gigahertz, enabling DACs, ADCs and their supporting digital circuitry to massively oversample and process the resulting digital data associated with dissimilar digital basebands in real-time.

Additionally, other embodiments of the invention deal with various PHY level optimizations accomplished by modifying the Radio Frequency (RF) spectrum to compensate for various channel impairments. Such optimizations can be simultaneously applied to multiple PHY layers by using pre-emphasis or de-emphasis of specific frequencies within the wired and/or wireless channel for the individual PHY layers. Data transfers over individual PHY layers can occur simultaneously (or not) and be based upon multiple dissimilar physical layer medias and or the same physical transport media using different portions of the radio frequency (RF) spectrum.

Additionally, there are other wireless and wired standards for both commercial and military applications, as well. Networked devices are now part of our day-to-day existence with no end in sight to their growth. The value of networking devices is best understood by looking at “Metcalfe's Law” which states: “The value of a telecommunications network is proportional to the square of the number of connected users of the system”. The ability to bridge multiple dissimilar networks together into one homogenous network as outlined in this patent further enhances “Metcalfe's law”.

At the PHY layer, conventional RF technologies typically employ sine waves that are modulated with data that is encoded into the sine wave's amplitude and/or frequency. For example, a conventional cellular phone must operate within a specified frequency band with a specified bandwidth and modulation. In the United States, some of the frequency bands the Federal Communications Commission (FCC) has allocated for cell phone communications are in the 800 to 900 MHz and 1.7 to 2.1 GHz frequency bands. There are many different frequency allocations, different modulation types, scrambling methods, synchronization techniques, Forward-Error-Corrections (FEC) methods, header and frame structures, along with a multitude of other parameters to enable reliable digital communications over both wireless and wired channels. These parameters are collectively known as the PHY/baseband when referring to a specific communications technology and standard. For example, one physical layer is the Open Systems Interconnect (OSI) model, or protocol (ISO/IEC 7498-1).

Typically, each PHY layer has an associated digital baseband responsible for managing frequency occupancy, modulation techniques, Forward Error Correction (FEC), forming data frames, synchronization, headers, checksums and other PHY layer parameters. It is these parameters that form the basis for individual PHY layer standards. When designing a PHY layer and the associated digital baseband, one must take into account the operating environment and actual physical transport media to be used in order to engineer the PHY and baseband to reliably operate. This is true for both wireless and wired PHY layer transports. Each physical media and operating environment has its own unique channel characteristics. By example, wireless must deal with multipath, fixed and mobile obstructions, weather and a host of other dynamically variable parameters unique to the propagation channel. When designing for wired medias, the channels tend to be more static with less variability. However, wired channels have other impairments such as group delay and typically substantial attenuation of signals at higher frequencies that band-limit the channel and affect the ability to reliably transport data at higher frequencies.

Many times channel impairments such as group delay, reflections and frequency attenuation cause the RF spectral characteristics of a specific PHY layer to become distorted in known and quantifiable ways. By understanding these distortions and how they cause the signal to be changed and modified, it is possible to restore and or provide compensations when transmitting these signals by pre-distorting the signal to compensate for the channel impairments. These channel impairments are unique to each wired and or wireless RF channel and can be time variant. One method to determine the unique RF spectral characteristics for a channel is to use a training sequence between a transmitter and receiver. The purpose of the training sequence is for the transmitter to transmit an RF signal of known spectral content that both the transmitter and receiver have a common locally stored reference. The transmitted RF signal propagates through the channel and is received by receiver. A comparative analysis is performed at the receiver using the locally stored reference as a baseline and then compares the received RF signal to the local reference. The receiver calculates the RF spectral difference between the two and then sends a RF spectrum map of the spectral differences. When the transmitter receives this information, it then uses it to derive the pre-distortions that need to be applied to the transmitted signal to compensate for channel impairments.

This is a dynamic process and can be done on a periodic basis independent of the receiver or whenever the receiver sends a signal to the transmitter requesting a new training sequence be initiated. Such a request can be triggered by a change in Bit-Error-Rate (BER), Frame-Error-Rate (FER) or any other metric used to qualify RF link quality.

Additionally, in many cases there are also regulatory limits that dictate how much RF power can be radiated from a wire at any particular frequency. Each wired media type has unique characteristics as to the RF frequencies they are capable of reliably propagating. Wired medias that are impedance controlled and shielded, such as coax, are the most preferred. However, other types of wired medias could be unshielded, with balanced and unbalanced pairs. Examples of such PHY layers would be Ethernet, USB and HomePlug.

As technology has advanced, it is not unusual for multiple PHY layers to exist within a single device. A laptop or pad device can have wireless PHY layers for Wi-Fi, Bluetooth and Cellular, as well as wired PHY layers for USB and Ethernet. Each of these wireless and wired PHY layers are often implemented as separate independent chips within the device due to the unique PHY and baseband requirements of each PHY layer. Each of these standard PHY/baseband standards is typically implemented as individual stand-alone silicon solutions. One feature of the present invention is that it integrates multiple PHY layers along with their associated basebands into a single comprehensive architecture.

The most common architecture used today when designing a communications system for both wired and wireless is the super heterodyne double conversion architecture The super heterodyne architecture has a number of distinct limitations. The bandwidth is typically limited to no more than a few hundreds of MHz and for digital modulations, the dynamic range is limited by the effective number of bits (ENOB) used by the digital-to-analog converter (DAC) to generate the RF spectrum and the analog-to-digital converter (ADC) used to detect and receive the RF signal. Additionally, super heterodyne designs rely on highly linear analog mixers and highly stable voltage-controlled oscillators (VCO) and phase-locked-loops (PLLs) to control the stability of these oscillators. Typically, each PHY/baseband requires its own unique super heterodyne RF section. A cell phone could contain five or more super heterodyne RF sections to accommodate the multiple frequency bands required for cellular, Wi-Fi and Bluetooth. Modern digital communications transmitters typically use DACs to generate a baseband RF signal and then utilize a super heterodyne architecture with analog mixers, oscillators and filters to up convert the baseband RF from the DAC to the desired RF operating frequency. In complex digital modulation schemes, the use of two DACs is required to produce a phase shifted “I” and “Q” component for digital modulation. When implementing a digital communications receiver, the receiver uses an inverse super heterodyne architecture as the digital transmitter, substituting ADC in place of the DACs.

One feature of the present invention is that it greatly simplifies the implementation of a system that requires multiple dissimilar PHY layers by entirely eliminating up/down mixers, converters, local oscillators, intermediate frequency (IF) filters, phase-lock loops (PLL) and other analog and RF components. Embodiments of the invention transfer these complexities from the analog/RF domain to the digital design domain greatly simplifying overall design. Moving the majority of the design to the digital domain enables much of the previous hardware to be reduced to digital circuitry and firmware abstractions. PHY/Baseband parameters, such as waveform shape, modulation, RF band of operation, FEC, framing and other parameters, instead of being implemented as fixed hardware, can now be replaced with programmable logic and firmware.

This is significant in that analog/RF circuitry does not scale well with silicon process technology. An analog/RF design fixed in 130 nm silicon does not typically translate well to smaller silicon process nodes, such as 90 nm or 65 nm. When transitioning an earlier analog/RF design to a different process node, typically the physical design and layout must be completely re-designed. Such is not the case with digital designs. When a digital design is re-accomplished for a different silicon process node, the same design can typically be scaled easily across multiple process nodes. For example, a 130 nm digital CMOS design can be easily scaled to 90 nm, 65 nm, 28 nm and beyond. Shifting the complexity from the RF/analog domain to the digital domain greatly increases the scalability of a design while simultaneously simplifying the architecture and implementation.

One embodiment of the present invention, a software controllable arbitrary waveform generator, is capable of generating multiple simultaneous PHY layers that do not require up or down conversion, and solves the above-described problems. Reducing the PHY/baseband processing to a programmable digital logic and associated firmware enables the ability to dynamically shape and modify the RF spectrum of individual PHY layers (or multiple PHY layers) simultaneously. Additional benefits include enabling the ability to modify and upgrade the PHY/baseband, even once the chipset has been manufactured, which greatly increases the flexibility of the platform. The output of the DAC can be routed to the appropriate analog front-end (AFE) output through the use of a filter and or impedance matching networks that can be of a fixed or programmable nature.

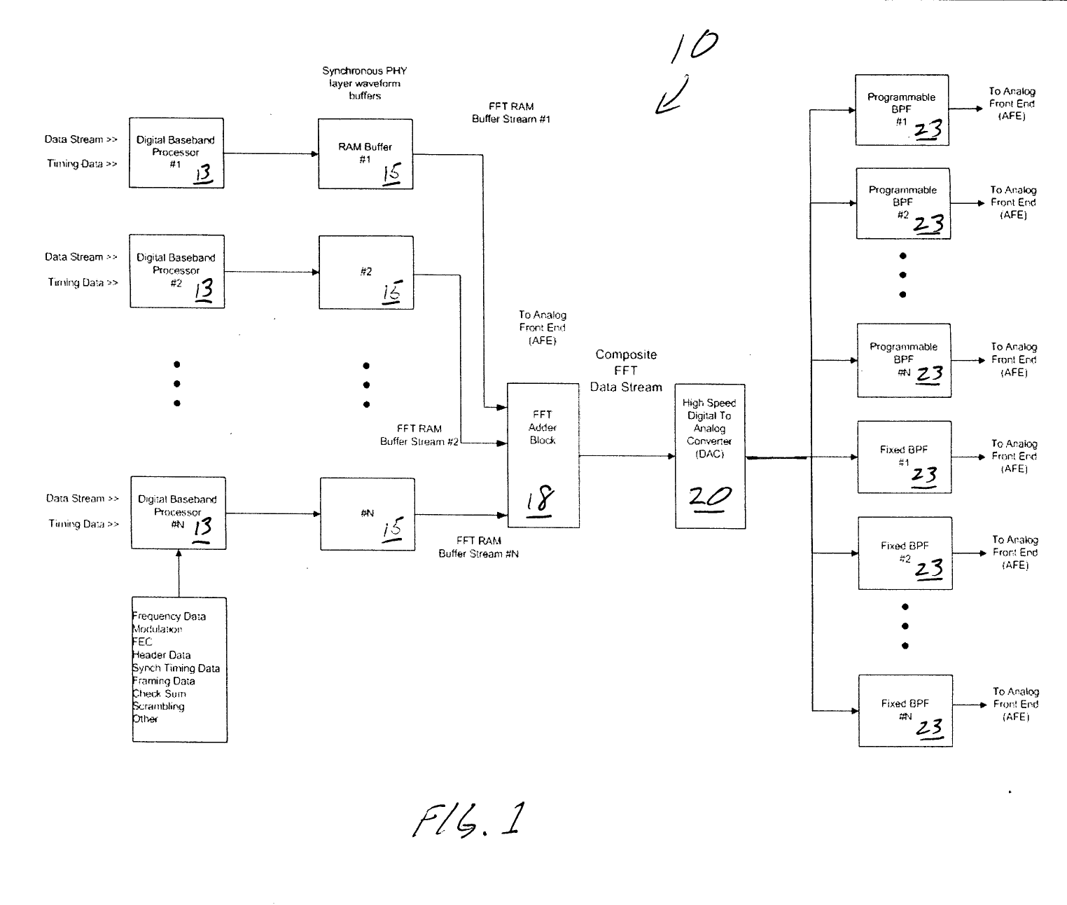

Referring now to FIG. 1, one embodiment of a software definable transceiver (SDT) 10 is illustrated. In the illustrated embodiment, a number of discrete Digital—Baseband—Processing elements (DBPE) 13 representing individual PHY layers receive data, such as audio, voice, video or other data for transmission. Put differently, in the illustrated embodiment, the SDT 10 and 30 comprises multiple DBPEs 13 and multiple random-access-memory (RAM) 15 buffers with each RAM buffer 15 corresponding to a specific PHY layer and DBPE 13. The contents of the RAM buffer 15 are formatted to represent the FFT of the waveform to be generated. The waveform is inclusive of all baseband and RF parameters.

As shown in FIG. 1, the array of DBPEs 13 1-through-N is connected in parallel to an array of random-access-memory (RAM) 15 1-though-N buffers that stream their data synchronously in real-time to the FFT adder. Any number of DBPE 13 and RAM 15 elements may be used in like manner to feed the FFT adder.

Each RAM buffer 15 is fed from a DBPE 13 which has taken the digital data stream and processed, as required, to add such PHY layer abstractions such as frame/packet synchronization timing data, overall frame/header data, data payload, forward-error-correction (FEC), scrambling and or checksums as well as RF frequency and modulation. The composite digital representation of these PHY layer abstractions are then fed from the DBPE 13 to the specific RAM buffer 15 for that specific PHY layer.

Each RAM buffer 15 temporal granularity may correspond to the sampling rate of the digital-to-analog converter (DAC) 20 or to an integer multiple of the DAC 20 sample rate with one memory address of individual RAM memory buffers 15 correlating to one sample of the DAC 20. The output of the multiple RAM buffers 15 are at the sample rate of the DAC 20 or an integer multiple and are synchronously combined in digital circuitry in a manner that sums the FFT of each individual PHY layer RAM buffer 15 so as to output a composite FFT of the summed PHY layer RAM buffers 15 to the high-speed digital-to-analog-converter (DAC) 20. The digital data stream that feeds the DAC 20 originates from the fast-Fourier-transform-adder (FFTA) 18. The FFTA 18 takes the FFT data streams from the individual RAM buffers 15 and aggregates them into one master FFT stream to feed the DAC 20.

The DBPE 13 and RAM buffer 15 output a digital data stream representative of the fast Fourier transform (FFT) of each received individual PHY layer data stream and this data is fed to a fast-Fourier-transform-adder (FFTA) 18 where the individual FFT data streams are aggregated into one data stream representative of all the individual FFT data streams from each DBPE 13. Multiple RAM buffers 15 stream their data synchronously in real-time to the FFT adder 18. The FFT adder 18 may comprise digital circuits capable of performing the functions of switching, summing, inverting, integrating and mixing and or multiplying the individual or integrated data streams. Additionally, the FFT adder 18 may be software controllable to enable or disable the various parameters listed above.

The FFT adder 18 combines the FFTs of the multiple streams into one global data stream, which then feeds the high-speed digital-to-analog converter (DAC) 20. Waveforms are defined in a dedicated memory buffer space for each PHY layer to be supported. The data is encoded so that once fed to the DAC 20, the PHY layer is reproduced in the frequency domain where all baseband features such as framing and FEC are present.

Referring again to FIG. 1, the DAC 20 sends the data to an array of programmable, or fixed band-pass filters (BPF) 23 connected in parallel. The BPFs 23 allow frequencies within a defined range to pass though to the analog front end (AFE) and reject, or attenuate frequencies outside the defined range.

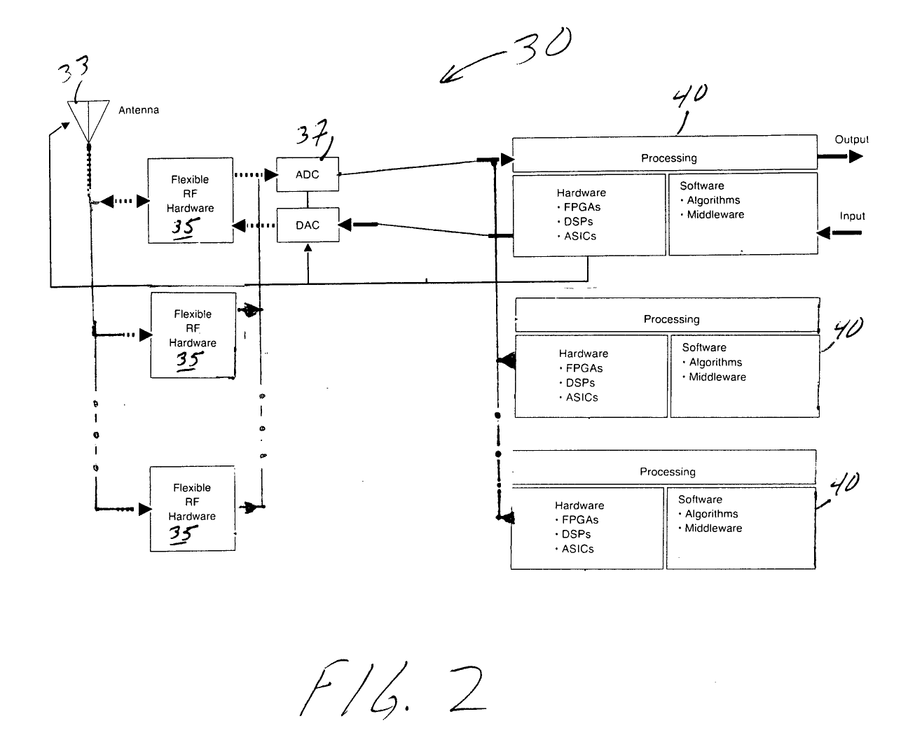

Looking now at FIG. 2, an alternative embodiment SDT 30 is illustrated. Similar to SDT 10, the embodiment shown in FIG. 2 is capable of receiving a plurality of dissimilar communication signals, each of the dissimilar communications signals comprising data associated with a dissimilar physical layer though antenna 33. The received signals are then processed through a plurality of radio frequency (RF) receiving elements 35 1-through-N connected in parallel with each RF receiving element 35 optimized for a dissimilar communications signal. The output from each RF receiving element 35 is then combined into one RF signal and sent to at least one analog-to-digital converter (ADC) 37. The output from the ADC 37 is then sent to a plurality of baseband processor engines (BPE) 40 1-through-N connected in parallel. Each BPE 40 includes a random-access-memory (RAM) buffer, with each RAM buffer containing a dissimilar physical layer representation. In addition, each BPE 40 may also include other elements, such as forward-error-correction (FEC), a scrambler, fast Fourier transforms, and other elements. The output of each BPE 40 is then sent to a high-speed DAC 20 (shown in FIG. 1), which then sends the data to an array of programmable, or fixed band-pass filters (BPF) 23 connected in parallel (also shown in FIG. 1). The BPFs 23 allow frequencies within a defined range to pass though to the analog front end (AFE) and reject, or attenuate frequencies outside the defined range.

Embodiments of SDTs 10 and 30 may use discrete RAM buffers 15 to represent the FFT and or Time domain representation of individual PHY layers in a non-super heterodyne architecture to generate the RF spectrum directly from a DAC 20 with no up conversion or intermediate frequency (IF). The use of multiple RAM buffers 15 representing dissimilar PHY layers with each PHY layer having at least one RAM buffer 15 or where one or more of the multiple RAM buffers 15 representing a node on the same network using the same PHY layer but each node with its own unique FFT or Time-Domain transform. Another embodiment of the would include the ability to mathematically combine the RAM buffers 15 in the frequency and or Time-Domain to form one data stream to be fed to a DAC 20 or multiple DACs to generate a hybrid RF spectrum representative of the combined data stream.

A feature of the present invention may include synchronizing a transmitter and receiver. The transmitter would then send a message to announce the start of a pre-defined training sequence from a library of possible training sequences. Each library of possible training sequences contain a pre-defined reference set of data symbols of known spectral content and duration. The transmitter would then transmit that pre-defined set of training data symbols over either a wireless or wired communications channel to a receiver or multiple receivers which would then receive that training data symbol set.

After reception, the receiver will then store the received data symbol sets unique spectral and temporal signal data to memory and then compare the training data symbol set data in memory to the receivers locally stored training data symbol set spectral and temporal data. After comparing the training data symbol set, the spectral and or temporal differences between the received training data symbol set and the locally stored training data symbol set are calculated. The spectral and temporal data difference between the two sets is then transmitted from the receiver back to the transmitter. This data is then used to calculate how to modify the transmitters FFT/Time-Domain profile to be used by the transmitter when communicating with that specific node on the communications link. That profile is stored in the transmitter's local long-term memory for use in all future communications with that specific node.

In one embodiment, the SDT 10 and 30 may employ multi Giga-sample DAC's and ADC's coupled with massive oversampling at both the transmitter and receiver, which enables significant performance increases and capabilities not achievable using a more traditional approach of using lower speed DAC's or ADC's that barely meet Nyquist requirements coupled to a super heterodyne architecture. Massive oversampling provides additional Effective-Number-Of-Bits (ENOB) for lower frequency applications. The lower the frequency, the more effective the oversampling is for enhancing the ENOB. For example, a 16 Gsps/6-bit DAC used to sample a 100 MHz signal requires a sampling rate of at least 200 MHz to meet Nyquist. With each bit of a DAC or ADC providing approximately 6 dB of gain, a 6-bit DAC will provide approximately 36 dB of dynamic range. Every time this sampling rate is doubled beyond Nyquist it provides an additional bit for the ENOB corresponding to 6 dB of additional dynamic range for the transceiver. Thus massive oversampling accomplishes the following: sampling at 400 MHz=7 bits ENOB producing approximately 42 dB dynamic range; sampling at 800 MHz=8 bits ENOB producing approximately 48 dB dynamic range; sampling at 1.6 Gbps=9 bits ENOB producing approximately 54 dB dynamic range; sampling at 3.2 Gbps=10 bits ENOB producing approximately 60 dB dynamic range; sampling at 6.4 Gbps=11 bits ENOB producing approximately 66 dB dynamic range; and sampling at 12.8 Gbps=12 bits ENOB producing approximately 72 dB dynamic range.

It should be clear that massive oversampling for both transmit and receive provides significant performance increase in the SNR for both DACs and ADCs. In this case, a 100 MHz signals SNR is increased from approximately 36 dB to over 72 dB. The reason for the approximate value of SNR is that there is implementation loss in digital transmitters and receivers.

Another feature of the present invention allows a wired or wireless device to have the ability to switch between various communications technologies and standards or to simultaneously support multiple communications technologies and standards. For example, wireless devices may communicate with Bluetooth, Wi-Fi, CWave ultra-wideband (UWB), multiple cellular standards as well as a host of other wireless communications technologies. Wired devices may communicate with MoCA or HomePlug as well as a host of other wired communications technologies. In the commercial and military market there is also MIL-STD-1553, CAN Bus and MOST Bus. One feature of the present invention is the generation and aggregation of multiple simultaneous RF waveforms that comply with a wide range wired and or wireless communications technologies.

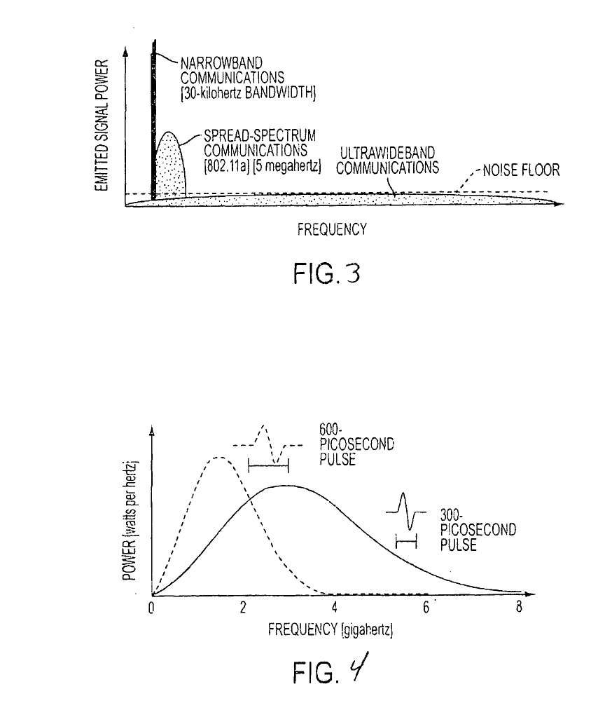

For example, one embodiment of the SDT 10 and 30 is capable of receiving and transmitting ultra-wideband communication technology, such as CWave UWB. Referring to FIGS. 3 and 4, impulse-type ultra-wideband (UWB) communication employs discrete pulses of electromagnetic energy that are emitted at, for example, nanosecond or picosecond intervals (generally tens of picoseconds to a few nanoseconds in duration). For this reason, this type of ultra-wideband is often called “impulse radio.” That is, impulse type UWB pulses may be transmitted without modulation onto a sine wave, or a sinusoidal carrier, in contrast with conventional carrier wave communication technology. Impulse type UWB may operate in virtually any frequency band and in some applications may not require the use of power amplifiers.

An example of a conventional carrier wave communication technology is illustrated in FIG. 3. IEEE 802.11a is a wireless local area network (LAN) protocol, which transmits a sinusoidal radio frequency signal at a 5 GHz center frequency, with a radio frequency spread of about 5 MHz. As defined herein, a carrier wave is an electromagnetic wave of a specified frequency and amplitude that is emitted by a radio transmitter in order to carry information. The 802.11 protocol is an example of a carrier wave communication technology. The carrier wave comprises a substantially continuous sinusoidal waveform having a specific narrow radio frequency (5 MHz) that has a duration that may range from seconds to minutes.

In contrast, an ultra-wideband (UWB) pulse may have a 2.0 GHz center frequency, with a frequency spread of approximately 4 GHz, as shown in FIG. 4, which illustrates two typical impulse UWB pulses. FIG. 4 illustrates that the shorter the UWB pulse in time, the broader the spread of its frequency spectrum. This is because bandwidth is inversely proportional to the time duration of the pulse. A 600-picosecond UWB pulse can have about a 1.8 GHz center frequency, with a frequency spread of approximately 1.6 GHz and a 300-picosecond UWB pulse can have about a 3 GHz center frequency, with a frequency spread of approximately 3.3 GHz. Thus, UWB pulses generally do not operate within a specific frequency, as shown in FIG. 3. Either of the pulses shown in FIG. 4 may be frequency shifted, for example, by using heterodyning, to have essentially the same bandwidth but centered at any desired frequency. And because UWB pulses are spread across an extremely wide frequency range, UWB communication systems allow communications at very high data rates, such as 100 megabits per second or greater.

Several different methods of ultra-wideband (UWB) communications have been proposed. For wireless UWB communications in the United States, all of these methods must meet the constraints established by the Federal Communications Commission (FCC) in their Report and Order issued Apr. 22, 2002 (ET Docket 98-153). The FCC April 22 Report and Order requires that UWB pulses, or signals occupy greater than 20% fractional bandwidth or 500 megahertz, whichever is smaller. Fractional bandwidth is defined as 2 times the difference between the high and low 10 dB cutoff frequencies divided by the sum of the high and low 10 dB cutoff frequencies. Specifically, the fractional bandwidth equation is:

$$Fractional Bandwidth = 2 \frac{{f}_{h} - {f}_{l}}{{f}_{h} + {f}_{l}}$$

where fₕ is the high 10 dB cutoff frequency, and fₗ is the low 10 dB cutoff frequency.

Stated differently, fractional bandwidth is the percentage of a signal's center frequency that the signal occupies. For example, a signal having a center frequency of 10 MHz, and a bandwidth of 2 MHz (i.e., from 9 to 11 MHz), has a 20% fractional bandwidth. That is, center frequency, f_{c}=(fₕ+fₗ)/2

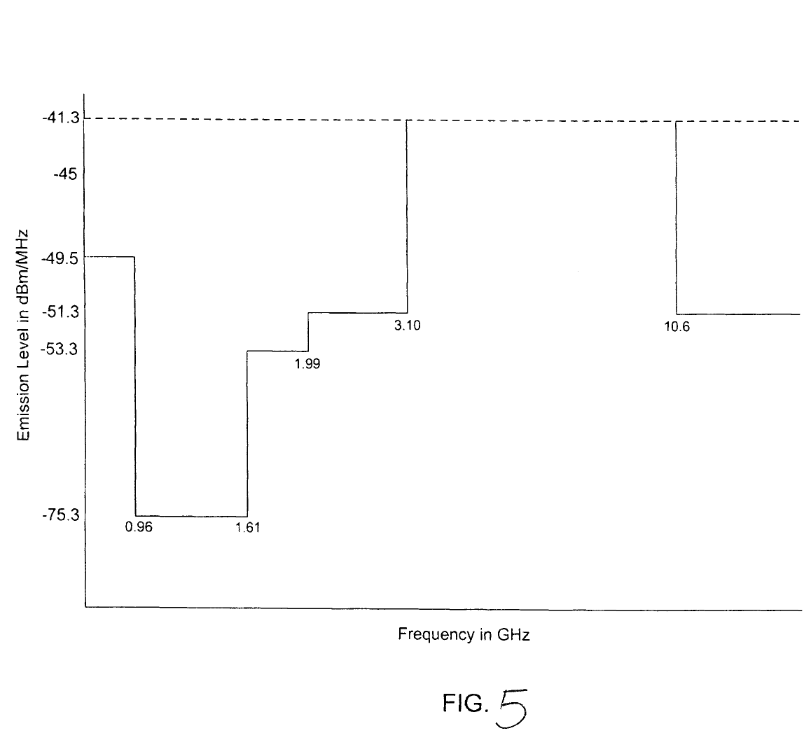

FIG. 5 illustrates the ultra-wideband emission limits for indoor systems mandated by the April 22 Report and Order. The Report and Order constrains UWB communications to the frequency spectrum between 3.1 GHz and 10.6 GHz, with intentional emissions to not exceed −41.3 dBm/MHz. The report and order also established emission limits for hand held UWB systems, vehicular radar systems, medical imaging systems, surveillance systems, through-wall imaging systems, ground penetrating radar and other UWB systems. It will be appreciated that the invention described herein may be employed indoors, and/or outdoors, and may be fixed, and/or mobile, and may employ either a wireless or wire media for a communication channel.

Generally, in the case of wireless communications, a multiplicity of UWB signals may be transmitted at relatively low power density (milliwatts per megahertz). However, an alternative UWB communication system, located outside the United States, may transmit at a higher power density. For example, UWB pulses may be transmitted between 30 dBm to −50 dBm.

One UWB communication method may transmit UWB pulses that occupy 500 MHz bands within the 7.5 GHz FCC allocation (from 3.1 GHz to 10.6 GHz). In one embodiment of this communication method, UWB pulses have about a 2-nanosecond duration, which corresponds to about a 500 MHz bandwidth. The center frequency of the UWB pulses can be varied to place them wherever desired within the 7.5 GHz allocation. In another embodiment of this communication method, an Inverse Fast Fourier Transform (IFFT) is performed on parallel data to produce 122 carriers, each approximately 4.125 MHz wide. In this embodiment, also known as Orthogonal Frequency Division Multiplexing (OFDM), the resultant UWB pulse, or signal is approximately 506 MHz wide, and has approximately 242-nanosecond duration. It meets the FCC rules for UWB communications because it is an aggregation of many relatively narrow band carriers rather than because of the duration of each pulse.

Another UWB communication method comprises transmitting discrete UWB pulses that occupy greater than 500 MHz of frequency spectrum. For example, in one embodiment of this communication method, UWB pulse durations may vary from 2 nanoseconds, which occupies about 500 MHz, to about 133 picoseconds, which occupies about 7.5 GHz of bandwidth. That is, a single UWB pulse may occupy substantially all of the entire allocation for communications (from 3.1 GHz to 10.6 GHz).

Another method of UWB communications comprises transmitting a modulated continuous carrier wave where the frequency occupied by the transmitted signal occupies more than the required 20 percent fractional bandwidth. In this method the continuous carrier wave may be modulated in a time period that creates the frequency band occupancy. For example, if a 4 GHz carrier is modulated using binary phase shift keying (BPSK) with data time periods of 750 picoseconds, the resultant signal may occupy 1.3 GHz of bandwidth around a center frequency of 4 GHz. In this example, the fractional bandwidth is approximately 32.5%. This signal would be considered UWB under the FCC regulation discussed above.

Thus, described above are different methods of ultra-wideband (UWB) communication. It will be appreciated that the present invention may be employed by any of the above-described UWB methods, or others yet to be developed.

Another embodiment of the present invention provides a method of supplying digital data to a digital-to-analog converter (DAC) without using a conventional digital signal processor. The present invention may provide pre-digitized communication waveforms to a DAC according to any desired communication requirement.

For example, one embodiment of the present invention may provide one or more tables containing a plurality of digitized waveforms. These digitized waveforms are mapped to desired communication symbols. For example, when the DAC is transmitting radio frequency energy as part of a wireless communication system, the stored waveforms may comprise waveforms modulated in accordance with the IEEE 802.11 standard, or the BLUETOOTH standard, or with an ultra-wideband technology communication standard.

By controlling the shape of a generated waveform to the tens of picoseconds, it is possible to limit the frequency content of the resultant waveform. One feature of the present invention provides a waveform generator for electronic communication systems that complies with FCC emission limit regulations without employing bandpass filters to reject out-of-band emissions.

For example, one embodiment of the present invention comprises a digital processor configured to encode data onto one or more representative transmission symbols. A waveform generator, such as a high-speed DAC, is configured to generate a waveform from the encoded representative transmission symbols. This waveform is then passed to an antenna and transmitted.

By using a high-speed DAC, such as one having a sampling rate of at least 10 giga samples per second, communication signals can be generated directly at their transmission frequency, including transmission frequencies of 5 gigahertz and above. Another feature of the present invention is that in one embodiment, only one DAC is required, as its high speed allows it to generate multiple communication signals at different frequencies, thereby eliminating the need for many components, such as multiple field-programmable-gate-arrays (FPGAs) found in conventional communication devices.

Another feature of the SDT 10 and 30 is that it allows the digital logic control unit to select the appropriate wired or wireless PHY layer, modeling the specified PHY layer as an FFT digital data stream that is then used to generate a carrier signal that is modulated by the data to be sent. All PHY layer abstractions are handled within the baseband as a digitally/software programmable abstraction and imparted to the DAC or DAC's for the transmitter and the ADC or ADC's for the receiver. This reduces the complexity and expense of device design in that neither analog nor RF modulation circuitry is necessary to impart data onto the carrier signal and no up or down RF conversion is required. An additional feature of the present invention is the ability to seamlessly bridge multiple communications standards for both wired and or wireless communications from PHY layer to another dissimilar PHY technology.

For example, a narrowband cellular signal may be received and then retransmitted using Wi-Fi or some other PHY technology in the home by using the same SDT 10 and 30 transceiver. This way, data streams from individual dissimilar PHY layer standards never need to be routed outside the SDT 10 and 30. This simplifies interfacing and integration at the system level. In one embodiment of the present invention, the DAC is configured to produce waveforms that have the desired characteristics of data and center frequency. This reduces the complexity and expense of the transmitter design by eliminating modulation and mixing hardware, potentially eliminating the need for bandpass filters. A still further object of the present invention is to provide an arbitrary waveform generator that can be software controlled to produce wired and wireless PHY layers compliant with multiple dissimilar PHY layers standards. Additionally, the present invention allows a wired or wireless communications device to bridge data from one dissimilar PHY layer to another dissimilar PHY layer.

One embodiment of the SDT 10 and 30 may analyze a received symbol, compare it to a locally stored reference, calculate symbol distortion in frequency or time-domain, and communicate specific distortions back to a transmitter. The transmitter then calculates pre-distortion of the symbol so that signal at the receiver is received with minimal channel impairments resembling as close as possible the intended ideal symbol.

The present invention may be employed in any type of network, be it wireless, wire, or a mix of wire media and wireless components. That is, a network may use both wire media, such as coaxial cable, and wireless devices, such as satellites, or cellular antennas. As defined herein, a network is a group of points or nodes connected by communication paths. The communication paths may use wires or they may be wireless. A network as defined herein can interconnect with other networks and contain sub-networks. A network as defined herein can be characterized in terms of a spatial distance, for example, such as a local area network (LAN), a personal area network (PAN), a metropolitan area network (MAN), a wide area network (WAN), and a wireless personal area network (WPAN), among others. A network as defined herein can also be characterized by the type of data transmission technology used by the network, such as, for example, a Transmission Control Protocol/Internet Protocol (TCP/IP) network, a Systems Network Architecture network, among others. A network as defined herein can also be characterized by whether it carries voice, data, or both kinds of signals. A network as defined herein may also be characterized by users of the network, such as, for example, users of a public switched telephone network (PSTN) or other type of public network, and private networks (such as within a single room or home), among others. A network as defined herein can also be characterized by the usual nature of its connections, for example, a dial-up network, a switched network, a dedicated network, and a non-switched network, among others. A network as defined herein can also be characterized by the types of physical links that it employs, for example, optical fiber, coaxial cable, a mix of both, unshielded twisted pair, and shielded twisted pair, among others.

As will be appreciated by one of skill in the art, embodiments, or portions of embodiments of the present invention may take the form of a computer program product which is embodied on one or more computer-usable storage media (including, but not limited to, disk storage, CD-ROM, optical storage, flash storage and so forth) having computer-usable program code embodied therein. That is, one embodiment may comprise a non-transitory computer readable medium encoded with a program having instructions being executed by a computer.

For example, one or more components of the present invention may be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagram block or blocks.

Thus, it is seen that software definable transceiver apparatus and method is provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

It is to be noticed that the term “comprising”, used in the claims, should not be interpreted as being limitative to the means listed thereafter. Thus, the scope of the expression “a device comprising means A and B” should not be limited to devices consisting only of components A and B. It means that with respect to the present invention, the only relevant components of the device are A and B.

What is claimed is:

1. A transceiver apparatus structured to receive a plurality of dissimilar communication signals, the transceiver apparatus comprising:
an antenna structured to receive the plurality of dissimilar communication signals, each of the dissimilar communications signals comprising data associated with a dissimilar physical layer;
a plurality of radio frequency (RF) receiving elements communicating with the antenna, each RF element optimized for each dissimilar communications signal, with the plurality of RF elements structured to process each of the received dissimilar communications signals;
a analog-to-digital converter (ADC) communicating with each of the RF receiving elements, the ADC structured to convert an analog signal into a digital signal;
a plurality of baseband processor engines (BPEs) communicating with the ADC, each BPE comprising a random-access-memory (RAM) buffer, with each RAM buffer comprising a dissimilar physical layer representation; and
where the digital signal is processed and formatted in each RAM buffer so that each BPE outputs recovered data unique to each dissimilar communications signal.

2. The transceiver apparatus of claim 1, where one of the plurality of dissimilar communication signals comprises an ultra-wideband signal that comprises a radio frequency signal that has at least a 20% fractional bandwidth.

3. The transceiver apparatus of claim 1, where one of the plurality of dissimilar communication signals comprises an ultra-wideband signal that comprises a radio frequency signal that occupies at least 500 Mega Hertz of a radio frequency spectrum.

4. The transceiver apparatus of claim 1, where one of the plurality of dissimilar communication signals comprises an ultra-wideband signal that comprises a multiplicity of electromagnetic pulses, with each of the multiplicity of ultra-wideband pulses having a duration that can range between 10 picoseconds to 100 milliseconds.

5. The transceiver apparatus of claim 1, where the plurality of dissimilar communication signals comprises a communication signal selected from a group consisting of: a substantially continuous sinusoidal signal, a plurality of electromagnetic pulses, a plurality of ultra-wideband pulses, a sinusoidal carrier waveform, a spread spectrum signal, an analog signal, and a digital signal.

6. The transceiver apparatus of claim 1, where the plurality of dissimilar communication signals is obtained from a medium selected from a group consisting of: a wire medium, a wireless medium, an optical fiber ribbon, a fiber optic cable, a single mode fiber optic cable, a multi-mode fiber optic cable, a twisted pair wire, an unshielded twisted pair wire, a plenum wire, a PVC wire, and a coaxial cable.

7. The transceiver apparatus of claim 1, where the plurality of dissimilar communication signals is transmitted through a communication medium selected from a group consisting of: a wire medium, a wireless medium, an optical fiber ribbon, a fiber optic cable, a single mode fiber optic cable, a multi-mode fiber optic cable, a twisted pair wire, an unshielded twisted pair wire, a plenum wire, a PVC wire, and a coaxial cable.

8. A method of processing a plurality of dissimilar communication signals, the method comprising the steps of:
receiving the plurality of dissimilar communication signals, each of the dissimilar communications signals comprising data associated with a dissimilar physical layer;
processing each of the received dissimilar communications signals through a radio frequency (RF) receiving element optimized for each dissimilar communications signal;
combining the RF outputs from each RF receiving element into one RF signal;
sending the plurality of dissimilar communication signals into at least one analog-to-digital converter (ADC);
sending an output from each of the ADCs into at least one baseband processor engine (BPE), with each BPE comprising a random-access-memory (RAM) buffer, with each RAM buffer comprising a dissimilar physical layer representation;
processing and formatting the dissimilar communication signals in each RAM buffer; and
outputting from the BPE recovered data unique to each dissimilar communications signal.

9. The method of claim 8, where one of the plurality of dissimilar communication signals comprises an ultra-wideband signal that comprises a radio frequency signal that has at least a 20% fractional bandwidth.

10. The method of claim 8, where one of the plurality of dissimilar communication signals comprises an ultra-wideband signal that comprises a radio frequency signal that occupies at least 500 Mega Hertz of a radio frequency spectrum.

11. The method of claim 8, where one of the plurality of dissimilar communication signals comprises an ultra-wideband signal that comprises a multiplicity of electromagnetic pulses, with each of the multiplicity of ultra-wideband pulses having a duration that can range between 10 picoseconds to 100 milliseconds.

12. The method of claim 8, where the plurality of dissimilar communication signals comprises a communication signal selected from a group consisting of: a substantially continuous sinusoidal signal, a plurality of electromagnetic pulses, a plurality of ultra-wideband pulses, a sinusoidal carrier waveform, a spread spectrum signal, an analog signal, and a digital signal.

13. The method of claim 8, where the plurality of dissimilar communication signals is obtained from a medium selected from a group consisting of: a wire medium, a wireless medium, an optical fiber ribbon, a fiber optic cable, a single mode fiber optic cable, a multi-mode fiber optic cable, a twisted pair wire, an unshielded twisted pair wire, a plenum wire, a PVC wire, and a coaxial cable.

14. The method of claim 8, where the plurality of dissimilar communication signals is transmitted through a communication medium selected from a group consisting of: a wire medium, a wireless medium, an optical fiber ribbon, a fiber optic cable, a single mode fiber optic cable, a multi-mode fiber optic cable, a twisted pair wire, an unshielded twisted pair wire, a plenum wire, a PVC wire, and a coaxial cable.

15. A method of simultaneously processing a plurality of dissimilar communication signals, the method comprising the steps of:
providing at least two baseband processor engines (BPE), with each BPE structured to process dissimilar communications signals;
sending an output of each BPE to a Fast Fourier Transform (FFT) element that sums the dissimilar communications signals into one single FFT data stream;
sending the single FFT data stream to at least one digital to analog converter (DAC) that is structured to generate data representing multiple dissimilar physical layers; and
sending an output of each DAC to at least two filters, with each filter sending one of the dissimilar physical layers to a transmitter element.

16. The method of claim 15, where one of the plurality of dissimilar communication signals comprises an ultra-wideband signal that comprises a radio frequency signal that has at least a 20% fractional bandwidth.

17. The method of claim 15, where one of the plurality of dissimilar communication signals comprises an ultra-wideband signal that comprises a radio frequency signal that occupies at least 500 Mega Hertz of a radio frequency spectrum.

18. The method of claim 15, where one of the plurality of dissimilar communication signals comprises an ultra-wideband signal that comprises a multiplicity of electromagnetic pulses, with each of the multiplicity of ultra-wideband pulses having a duration that can range between 10 picoseconds to 100 milliseconds.

19. The method of claim 15, where the plurality of dissimilar communication signals comprises a communication signal selected from a group consisting of: a substantially continuous sinusoidal signal, a plurality of electromagnetic pulses, a plurality of ultra-wideband pulses, a sinusoidal carrier waveform, a spread spectrum signal, an analog signal, and a digital signal.

20. The method of claim 15, where the plurality of dissimilar communication signals is transmitted through a communication medium selected from a group consisting of: a wire medium, a wireless medium, an optical fiber ribbon, a fiber optic cable, a single mode fiber optic cable, a multi-mode fiber optic cable, a twisted pair wire, an unshielded twisted pair wire, a plenum wire, a PVC wire, and a coaxial cable.
